(19) United States
(12) Patent Application Publication
(10) Pub. No.: US 2024/0301181 A1
(43) Pub. Date: Sep. 12, 2024

(54) COMPATIBILIZATION AND IMPACT MODIFICATION OF POST CONSUMER RESINS

(71) Applicant: Equistar Chemicals, LP, Houston, TX (US)

(72) Inventors: Nicholas M. Briggs, Cincinnati, OH (US); Ryan Kramb, Monroe, OH (US); Bryan S. Schley, Cincinnati, OH (US); Timothy J. Skillman, Maineville, OH (US); Jeffrey J. Strebel, Cincinnati, OH (US); Jeanine A. Smith, Maineville, OH (US); David C. Holliman, Maineville, OH (US); Rocio S. Garay, Cincinnati, OH (US); Gilles Jobin, Quebec (CA); Brooke Thacker, Cincinnati, OH (US)

(73) Assignee: EQUISTAR CHEMICALS, LP, Houston, TX (US)

(21) Appl. No.: 18/595,783

(22) Filed: Mar. 5, 2024

Related U.S. Application Data
(60) Provisional application No. 63/450,262, filed on Mar. 6, 2023.

(51) Int. Cl. C08L 23/06; C08L 23/08; C08L 23/12; C08L 23/14

(52) U.S. Cl. CPC C08L 23/06; C08L 23/0807; C08L 23/12; C08L 23/142; C08L 2205/025; C08L 2205/035; C08L 2205/08; C08L 2207/02; C08L 2207/062; C08L 2207/20

(57) ABSTRACT

Compositions comprising post-consumer recyclate polyolefins are described herein. The post-consumer recyclate are blended with virgin resin using a compatibilizer and an impact modifier. The resulting blends showed improved physical properties compared with compositions not containing compatibilizers and/or the impact modifier. The variability in physical properties upon addition of compatibilizer and impact modifier allows for selection of resins to produce blended resins with desired physical properties for a wider range of applications than was previously possible with recycled plastics.

### PRIOR RELATED APPLICATIONS

This application claims the benefit of priority to U.S. Provisional Application No. 63/450,262, filed on Mar. 6, 2023, which is incorporated herein by reference in its entirety.

### FEDERALLY SPONSORED RESEARCH STATEMENT

Not applicable.

### FIELD OF THE DISCLOSURE

The disclosure generally relates to blends of virgin resins and post-consumer recyclate (“PCR”) resins with both compatibilizers and impact modifiers to alter the physical properties for improved processability, including processes of making same, and products made therefrom.

### BACKGROUND OF THE DISCLOSURE

Heightened standards of living and increased urbanization have led to an increased demand for polymer products, particularly polyolefin plastics. Polyolefins are synthetic resins formed by the polymerization of olefins. Polyolefins have been frequently used in commercial plastics applications because of their outstanding performance and cost characteristics.

Polyethylene (PE), for example, made from polymerization of ethylene monomers, has become one of the most widely used and recognized polyolefins. It is strong, extremely tough, and very durable, and is used in a variety of applications, such as making common goods including plastic bags, wraps, milk cartons, trash cans, pipes, bottles, etc.

Similarly, polypropylene (PP) is mechanically rugged, yet flexible, is heat resistant, and is resistant to many chemical solvents like bases and acids. Thus, it is ideal for various end-use industries, mainly for packaging and labeling, textiles, plastic parts and reusable containers of various types.

The downside to the high demand for polyolefin plastics is the increase in waste. Post-consumer plastic waste typically ends up in landfills, with about 12% being incinerated and about 9% being diverted to recycling. In landfills, most plastics do not degrade quickly, becoming a major source of waste that overburdens the landfill. Incineration is not an ideal solution to treating the plastic wastes as burning leads to the formation of carbon dioxide and other greenhouse gas emissions. Thus, there has been much interest in developing methods of recycling plastic waste to reduce the burden on landfills while being environmentally friendly.

However, the drawback to recycling plastic is the difficulty in successfully producing commercially usable or desirable products. Plastic waste recycling currently includes washing the material and mechanically reprocessing. As post-consumer plastic waste has often undergone stress cracking or been exposed to repeated heating cycles or UV light before being recycled, reprocessed materials have a reduction in mechanical properties compared to the virgin materials. While recycled materials are easily used for items like plastic bags and disposable packaging, they may be undesirable for uses requiring safety, strength, or performance.

Thus, there exists a need for the development of compositions that utilize recycled post-consumer polyolefin waste for the production of a much greater range of commercially usable products.

### SUMMARY OF THE DISCLOSURE

The present disclosure is directed to polyolefin compositions comprising post-consumer recycled (PCR) polyolefin resins. In particular, the compositions combine virgin polyolefin resins and PCR polyolefin resins plus at least a compatibilizer resin and an impact modifier. The compatibilizer resin enhances the dispersion of the PCR resins and virgin resins. The additional impact modifier improves impact resistance and helps in further adjusting the impact to stiffness ratio. The resulting plastics are suitable for a wide range of uses in packaging, food packaging, and others.

### DETAILED DESCRIPTION

Blending of virgin resins and PCR resins with different physical properties often yields undesirable contamination. In addition, the final blend may have undesirable physical properties, being weakened by the aging, additional processing, and/or contaminants. However, we have discovered that the addition of a small amount of compatibilizer plus impact modifier produces resins that are suitable for a wide a variety of uses. Thus, this application describes blends of virgin and recycled resin blended with both a compatibilizer and an impact modifier, their manufacture and various uses.

Blending of the ingredients may be performed in a number of ways. In one exemplary approach, virgin polyolefins, PCR polyolefins and the compatibilizer may be blended together via a twin-screw extruder. After blending, the impact modifier is added during a forming process to make the part (such as injection molding, thermoforming, etc.).

Alternatively, in another approach, virgin resins, PCR resins, the compatibilizer, and impact modifier may all be blended together at the same time via a twin-screw extruder. After blending, the material would then be used in a forming process to make a part (such as injection molding, thermoforming, etc.).

In more detail, the proof of concept blending was done with extruder barrel temperature that ranged from 150° C. at the feed throat and 220° C. at the die, although ranges of 125-299° C. are acceptable and can vary even further depending on the chosen starting materials. The extruder output was set to 100 lbs/hr, but can range from about 50-150 lbs/hr. The specific mechanical energy was 0.25 kW/Kg/hr, but can include ranges of about 0.15-0.5 kW/Kg/hr. The extruder screw speed used was 300 rpm, but ranges of about 200-400 or even wider are acceptable, providing that sufficient mixing is achieved.

In our proof of concept work, the physical properties of the inventive resins, such as Flex Modulus, Notched Izod, Elongation at Break and Yield, Tensile Strength at Break and Yield were all measured. The comparison and changes in the physical properties upon addition of compatibilizers and/or impact modifiers indicate that the blended resins may be developed for various desired physical properties with an array of resins for different applications. Even when containing significant amounts of recycled plastics, the blends described herein are strong and flexible and have sufficient impact resistance to be useful in a variety of packaging needs.

Additives may also be used along with the four basic ingredients. These additives are generally added to impart color or improve certain properties, and may include a dye, pigment, or any substances that may impart metallic or pearlescent effects, including polymeric compositions. The blends may also include antioxidants, plasticizers, lubricants, flame retardants, nucleators, slip agents, UV light stabilizers, anti-scratch agents, or other additives as needed for the application or consumer product to be produced.

The final blended composition may then be used to prepare articles that include sheets, films, pipes, strands, tubes, containers, pellets, or custom profiles specific to each application. Caps and closures may also be molded by the blended composition of resins. Plastic bottles, bags, food containers, plastic cutting boards, water tanks, plastic toys and playground equipment, piping and fittings, medical equipment and containers, signage, automotive parts and interiors, plastic furniture, and the like may be made from the blended plastic.

The virgin resin can be any polyolefin, including C₂-C₁₀ alpha-olefins, low density polyolefins, medium density polyolefins, and high density polyolefins. Particular useful polyolefins include polyethylene (PE), polyisobutylene, polymethylpentene, and a preferred polyolefin is polypropylene (PP). The PCR resin is also any of these polyolefins, but the invention is the most beneficial when the PCR resin differs from the virgin resin and thus benefits from the added compatibilizer. A preferred PCR polyolefin is polyethylene, especially a medium—or more preferably a high-density polyethylene.

Compatibilizers are macromolecular species exhibiting interfacial activities in heterogeneous polymer blends. Usually, the chains of a compatibilizer have a blocky structure, with one constitutive block miscible with one blend component and a second block miscible with the other blend component. The compatibilization methods can be divided into two categories.
1. Addition of (i) a small quantity of a component which is miscible with both phases, (ii) a small quantity of copolymer whose one part is miscible with one phase and another with another phase, (iii) a large amount of a core-shell, multipurpose compatibilizer-impact modifier; or
2. Reactive compatibilization, which uses such strategies as (i) trans-reactions, (ii) reactive formation of graft, block, or lightly cross-linked copolymer, (iii) formation of ionically bonded structures, (iv) mechanochemical blending that may lead to chain breaks and recombination, thus generating copolymers.

The compatibilizer resin described herein is of the first type and is a heterophasic copolymer (HECO). The HECO has two components:
A. polypropylene homopolymers and/or polypropylene copolymers having small amounts of ethylene or C₄-C₁₀ α-olefins;
B. a rubber that can be a bipolymer or terpolymer with monomers comprising propylene, ethylene, and/or other α-olefin co-monomers.

More specifically, component A of the compatibilizers is heterophasic ethylene-propylene copolymer. These are a unique group of polyolefins produced through the copolymerization of ethylene and propylene, with the aim of improving the impact properties of the PP homopolymer matrix with dispersed rubbery amorphous copolymer phase. The HECO A component may also be visbroken with peroxides to increase its MFR.

Some examples of commercially available compatibilizers used in the present compositions include, but are not limited to, the PRO-FAX™, ADFLEX™, MOPLEN™, ADSTIF™, HOSTACOM™, PURELL™, and HIFAX™ HECOs from LYONDELLBASELL® (Houston, TX).

Impact modifiers are materials added to polymers to improve the durability, thermal stability, flexibility and impact strength of the plastic resins. The amount of impact modifier to add depends upon the level of impact resistance need for the end use. Suitable impact modifiers for use herein include olefin block copolymers. Other impact modifiers, for example, methacrylate butadiene styrene terpolymer, acrylate polymethacrylate copolymer, chlorinated polyethylene, ethylene vinyl acetate copolymer (EVA), and/or acrylonitrile butadiene styrene terpolymer (ABS) may also be used.

For general purpose thermoplastic elastomer applications, like molding and profile extrusion, ethylene-butene (EB), ethylene-hexene, ethylene-octene, and the like are polyolefin elastomers (POE) used as impact modifier. Blends of polypropylene and styrene-butadiene-styrene (SBS) and styrene-ethylene/1-butene-styrene (SEBS) block copolymers are used as impact modifier for polypropylene and polyethylene to toughen the polymer and improve tensile properties. A combination of olefin block copolymer with ethylene and/or styrene may be expended for desired physical property and application.

Some examples of commercially available impact modifiers used in the present invention include INFUSE™ and ENGAGE™ branded material from DOW CHEMICAL®, VISTAMAXX™ and EXACT™ branded material from EXXONMOBIL®, KRATON G™ branded materials from KRATON® CORP., and DELTAMAX™ from MILLIKEN®.

The invention thus includes any one or more of the following embodiments in any combination(s) thereof:

A composition comprising: i) a virgin resin with a first polyolefin; ii) a post-consumer recyclate or PCR resin having a second polyolefin; iii) a compatibilizer having a semi-crystalline matrix and a rubber component, and iv) an impact modifier.

A composition comprising: i) a virgin resin with a first polypropylene; ii) a PCR resin having a second polyolefin; iii) a polypropylene-based compatibilizer wherein the polypropylene-based compatibilizer has a semi-crystalline matrix and a rubber component, and iv) an impact modifier.

A composition comprising: i) a virgin resin having a polypropylene homopolymer; ii) a polyethylene especially a medium or high density polyethylene post-consumer recyclate (PCR) resin; iii) a compatibilizer, wherein the compatibilizer has a semi-crystalline propylene homopolymer and a partially amorphous copolymer of ethylene and propylene; and iv) an impact modifier containing copolymer of ethylene and butene.

A composition comprising: i) a virgin resin having a polypropylene homopolymer; ii) a high density polyethylene (HDPE) post-consumer recyclate (PCR) resin; iii) a compatibilizer, wherein the compatibilizer has a semi-crystalline propylene homopolymer and a partially amorphous copolymer of ethylene and propylene; and iv) an impact modifier containing copolymer of ethylene and 1-octene.

A composition comprising: i) a virgin resin having a polypropylene homopolymer; ii) a high density polyethylene (HDPE) post-consumer recyclate (PCR) resin; iii) a compatibilizer, wherein the compatibilizer has a semi-crystalline propylene homopolymer and a partially amorphous copolymer of ethylene and propylene; and iv) an impact modifier containing copolymer of ethylene and hexene.

Any of the compositions described herein, wherein the first and second polyolefin are selected from a group consisting of C₁-C₁₀. C₂-C₈ or C₄-C₆ alpha-olefins, but preferred are polypropylene and polyethylene. Any of the compositions described herein, wherein first polyolefin and the second polyolefin are different polyolefins, but they may also be same. Any of the herein described compositions, wherein the first polyolefin is polypropylene, high density polypropylene, polyethylene, or high density polyethylene, and the second is polyethylene or high density polyethylene. Most preferred is virgin PP and recycled PE, especially medium or high density PE.

Any of the compositions described herein, wherein the total amount of the virgin polyolefins may be between 5-95 wt. %. Preferably, the virgin resin is 15-60 wt. %; 20-55 wt. %, or 25-55 wt. %. The MFR (230° C., 2.16 Kg) of the virgin resin is between 2-2000 g/10 min, preferably between 100-200 g/10 min. Most preferred are any of the exact values provided in the Tables herein.

Any of the herein described compositions wherein the HDPE PCR resin is present in an amount of about 5-85 wt. %, 5-20 wt. %, 10-30 wt. %, 15-35 wt. %, 35-50 wt. %. The MFR (190° C., 2.16 kg) of the chosen PCR resin is 0.5-1 g/10 min or 0.08-0.9 g/10 min, or 0.85 g/10 min. Most preferred are any of the exact values provided in the Tables herein.

Any of the compositions described herein, wherein the virgin and PCR resins have a density between about 0.940 to about 0.970 g/cm³, or between about 0.940-0.960 g/cm³, or between about 0.950-0.970 g/cm³, or 0.945-0.965 g/cm³. The densities of the two resins will usually differ, but they can be the same or similar.

Any of the herein described compositions wherein the compatibilizer comprises i) 20% to about 80% by weight a semi-crystalline propylene homopolymer with a melt flow rate of about 20 to about 60 g/10 min; and ii) 20% to 80% by weight partially amorphous copolymer is ethylene and propylene with an ethylene content of about 15 to about 52% and the intrinsic viscosity of the xylene soluble fraction at room temperature of about 3.0 to 5.0 dl/g (in decalin).

Any of the herein described compositions wherein the semi-crystalline propylene homopolymer of the compatibilizer further comprises of i) 25% to 75% of a propylene polymer by weight of semi-crystalline propylene homopolymer (a), having a melt flow rate of about 1.2 g/10 min; and ii) 25% to 75% of a propylene polymer by weight of semi-crystalline propylene homopolymer (a), having a melt flow rate of about 73 g/10 min; wherein the ratio of melt flow rate of component ii) and i) is 60 and the propylene polymers i) and ii) are selected from a group consisting of a propylene homopolymer, a random copolymer of propylene containing up to 5% of ethylene, and a random copolymer of propylene containing up to 6% of at least one C₄-C₁₀ alpha-olefin and optionally up to 5% of ethylene; wherein (a) has a polydispersity index from 4 to 7.

Any of the herein described compositions wherein the compatibilizer contains a) about 50% semi-crystalline propylene homopolymer with a MFR of about 90 g/10 min, and b) about 35% partially amorphous copolymer of ethylene and propylene containing up to about 48% ethylene content.

Any of the compositions described herein, wherein the compatibilizer is present in an amount of about 5-65 wt. %, 10-40 wt. %, 15-30 wt. %, 30-45 wt. % or 30-60 wt. %. Most preferred are any of the exact values provided in the Tables herein.

Any of the herein described compositions wherein the impact modifier is a copolymer of ethylene and olefin selected from the group consisting of butene, hexene, and 1-octene. Any of the herein described compositions wherein the impact modifier may be ethylene-vinyl acetate copolymer functionalized with acrylic acid.

Any of the compositions described herein, wherein the impact modifier is present in an amount of about 5-20 wt. %, 10-20 wt. %, 10-15 wt. %, or 5-12 wt. %. Most preferred are any of the exact percentages provided in the Tables herein.

Any of the compositions described herein, wherein the MFR of the final blended composition is about 40 to 60 g/10 min, alternatively, from 15 to 30 g/10 min, 20 to 40 g/10 min, 45-55 or about 50 g/10 min. Any of the compositions described herein, wherein the Flex Modulus of the final blended composition is 100-200 kpsi, the N Izod is 0.5-2.5 ft-lbs/in, the Tensile at Yield is 1000-4000% or about 2000-3000\hat{ }%, and the elongation at yield is about 1-10%. Most preferred are any of the exact values provided in the Tables herein.

Any article formed by the compositions described herein. The articles may include plastic cups, caps, closures, dispensers, plastic bottles, pails, plastic food containers including bottles, dairy containers and beverage cups, water bottles, chemical containers, medical components (e.g., syringes, vials, pill container, specimen bottles), pipes, toys, automotive parts (e.g., batteries, bumpers, panels, interior and exterior trims), outdoor furniture, luggage, etc.

A method of making any of the resins described herein wherein the following are added to a twin screw extruder and blended together: i) a virgin resin with a first polyolefin; ii) a post-consumer recyclate or PCR resin having a second polyolefin; iii) a compatibilizer having a semi-crystalline matrix and a rubber component, and iv) an impact modifier.

A method of making any of the resins described herein wherein the following are added to a twin screw extruder and blended together to form a blended resin: i) a virgin resin with a first polyolefin; ii) a post-consumer recyclate or PCR resin having a second polyolefin; and iii) a compatibilizer having a semi-crystalline matrix and a rubber component; then an impact modifier is added to the blended resin and formed into a desired part.

Any method herein wherein the articles are formed by injection molding, extrusion, thermoforming, stretch blow molding and injection blow molding.

As used herein, the term ‘virgin’ refers to an unused material, as provided by the manufacturer and has not yet been processed into a consumer item.

As used herein, the term ‘recycle’ means processing an item into new products or materials. ‘Post-consumer recycled’ or ‘PCR’ resin refers to plastic that has been molded into a product, used by the consumer and then recycled.

As used herein, the term “polymer” means a macromolecular compound prepared by polymerizing monomers of the same or different type. The term “polymer” includes homopolymers, copolymers (including block and random), polymers with three or more monomers, interpolymers, and so on.

As used herein, the term “homopolymer” or “HOMO” refers to a polymer consisting solely or essentially of units derived from a single kind of monomer, e.g., polyethylene homopolymer is a polymer comprised solely or essentially of units derived from ethylene, and polypropylene homopolymer is a polymer comprised solely or essentially of units derived from propylene.

As used herein, the term “copolymer” refers to a polyolefin polymer that contains two or more types of alpha-olefin monomer units.

As used herein, the term “rubber” refers to bipolymer or terpolymer polymer containing partially amorphous copolymer of ethylene and olefin such as propylene or butene wherein the ethylene content is >35%. The rubber has elastomeric properties.

The term “heterophasic copolymer” or “HECO” in the present disclosure refers to a blend of homopolymers and/or copolymers that contains two components: a semi-crystalline polypropylene-based matrix and a rubber component that can be a bipolymer or a terpolymer, wherein the rubber component makes up less than 30% of the HECO. To control the range of MFR for a HECO in the compatibilizers, the HECO may be visbroken with peroxide. Visbroken HECO polypropylene produces polymers of controlled rheology that is, polymers having increased MFR. Visbreaking the HECO may be necessary for certain applications of the final product.

As used herein, “visbreaking” or “visbroken polymer” or “visbroken HECO” in the present disclosure refer to structural modification to polymers by reactive postreactor processes, usually by the addition of peroxides. Visbreaking is carried out to control rheology of polymers leading to a higher MFR.

As used herein, the term “α-olefin” or “alpha-olefin” means an olefin of the general formula CH₂═CH—R, wherein R is a linear or branched alkyl containing from 1-10 or 2-8 or 4-6 carbon atoms. The α-olefin can be selected, for example, from propylene, 1-butene, 1-pentene, 1-hexene, 1-octene, 1-dodecene, and the like, but preferred are propylene and ethylene.

As used herein, percentages are weight percentage (unless noted otherwise) of the total weight of the four basic components added together, but excludes any minor additives such as colorants, lubricants, and the like.

Flexural Modulus (or “Flex Modulus”) and flexural strength (or “flex strength”) is defined as the tendency of a material to bend. It is a ratio of stress to strain during a flexural deformation (or bending). It is related to the amount of weight a resin can handle without breaking. Flex Modulus is measured in megapascal (MPa) and using ASTM D790-03 (entitled “Standard Test Methods for Flexural Properties of Unreinforced and Reinforced Plastics and Electrical Insulating Materials”). The term “ASTM D790” as used herein refers to the test method published in 2003.

Notched Izod impact strength measures the impact resistance of materials and is given in ft-lb/in. It is a measure of the material's resistance to impact from a swinging pendulum. In general, it is a measure of the toughness of a resin. The higher the Notched Izod value, the tougher the resin is. The standard testing method for Notched Izod impact strength is Method A of ASTM D256-06 (entitled “Standard Test Methods for Determining the Izod Pendulum Impact Resistance of Plastics”). The term “ASTM D256” as used herein refers to the test method published in 2006. Unless otherwise noted, the temperature for this test is 73° F.

Tensile strength and tensile modulus are indicative of a material's resistance to deformation and are measured in megapascal (MPa). Tensile elongation (or Strain) is the stretching a material can undergo. They are measured as % and using ASTM D638-03 (entitled “Standard Test Method for Tensile Properties of Plastics”). The elongation is the percent change in length from original to rupture. The term “ASTM D638” as used herein refers to the test method published in 2003.

Density of the polyolefins is determined in accordance with ASTM D1505 (entitled “Standard Test Method for Density of Plastics by the Density-Gradient Technique”) and is given in g/cm³. The term “ASTM D1505” as used herein refers to the test method published in 2018.

Xylene soluble component in the polyolefins was determined in accordance with ASTM D5492 (entitled “Standard Test Method for Determination of Xylene Solubles in Propylene Plastics”) and is given in percentages (%). The intrinsic viscosity of the fraction soluble in xylene was determined using decalin or tetrahydronaphthalene at 135° C., in accordance with ISO 1628-1 (entitled “Plastics-Determination of the viscosity of polymers in dilute solution using capillary viscometers”). The term “ASTM D5492” as used herein refers to the test method published in 2017.

Monomer content of ethylene in each of the compatibilizer and polyolefins described in the disclosure was determined by carrying out specific IR measurements on a pressed plaque prepared with the disclosed compositions and relating those measurements to previously derived calibration curves of known standard concentrations, in accordance with ITM 20061 (entitled “Infrared Spectrophotometric Determination of Ethylene Content in Propylene-Ethylene Semi crystalline Copolymers”)

As used herein, the ‘melt flow rate’ (MFR) (aka “melt index” (MI) or ‘melt flow index’ (MFI)), refers to the measure of the ease of flow of melted plastic. It is a typical index for quality control for thermoplastics. It is expressed in g/10 min. The standard test method for determining melt flow rates of thermoplastics is ASTM D1238 (“Standard Test Method for Melt Flow Rates of Thermoplastics by Extrusion Plastometer”), and it is carried out by using an extrusion plastometer. ASTM D1238 measures the melt flow rate at 190° C. for polyethylene and 230° C. for polypropylene, uses 2.16 kg of weight, and is given in gram/10 min. After a specified preheating time, resin is extruded through a die with a specified length and orifice diameter under prescribed conditions of temperature, load, and piston position in the barrel. The “melt flow range” is a range of melt flow rates.

The use of the word “a” or “an” in the claims or the specification means one or more than one, unless the context dictates otherwise.

The term “about” means the stated value plus or minus the margin of error of measurement or plus or minus 10% if no method of measurement is indicated.

The use of the term “or” in the claims is used to mean “and/or” unless explicitly indicated to refer to alternatives only or if the alternatives are mutually exclusive.

The terms “comprise”, “have”, “include” and “contain” (and their variants) are open-ended linking verbs and allow the addition of other elements when used in a claim. The phrase “consisting of” is closed and excludes all additional elements. The phrase “consisting essentially of” excludes additional material elements, but allows the inclusions of non-material elements that do not substantially change the nature of the invention, such as instructions for use, colorants, lubricants, and the like. Any claim or claim element introduced with the open transition term “comprising,” may also be narrowed to use the phrases “consisting essentially of” or “consisting of,” and vice versa. However, the entirety of claim language is not repeated verbatim in the interest of brevity herein.

The following abbreviations are used herein:

| ABBREVIATION | TERM |
|---|---|
| ABS | Acrylonitrile butadiene styrene |
| ASTM | American Society for Testing and Materials |
| EB | Ethylene-butene |
| EVA | Ethylene vinyl acetate |
| HECO | Heterophasic copolymer |
| HDPE | High Density Polyethylene |
| GPC | Gel permeation chromatography |
| HDPE | High Density Polyethylene |
| MFR | Melt flow rate aka melt index or melt flow index |
| NB | No Break |
| PCR | Post-consumer recyclate |
| PE | Polyethylene |
| POE | Polyolefin elastomer |
| PP | Polypropylene |
| PDI | Polydispersity index |
| SBS | Styrene-butadiene-styrene |
| SEBS | Styrene-ethylene/1-butene-styrene |
| TPO | Thermoplastic polyolefin |

The examples herein are intended to be illustrative only, and not unduly limit the scope of the appended claims. Although the present disclosure and its advantages have been described in detail, it should be understood that various changes, substitutions, and alterations can be made herein without departing from the scope of the disclosure as defined in the claims.

### Virgin Resin

Four different base virgin polypropylene resins (from LyondellBasell, Houston, TX) were used in the following examples. The virgin polypropylene resins labeled virgin resin A (VRA), virgin resin B (VRB), virgin resin C (VRC) and virgin resin D (VRD), each varied in their MFR range from ultra-high MFR (VRA) to very low MFR (VRC). The physical properties of the four virgin polypropylene resins are listed in Table 1.

The properties of the virgin resins are shown in Table 1.

TABLE 1
Physical Properties of Virgin Resins

| Physical Properties | VRA | VRB | | VRC | | VRD | |
|---|---|---|---|---|---|---|---|
| MFR (230° C./2.16 kg) | 1800 g/10 min | 65 g/10 min | | 2.3 g/10 min | | 107 g/10 min | |
| Flexural Modulus (1.3 mm/min, | | 290 | kpsi | 275 | kpsi | 215 | kpsi |
| 1% secant, Procedure A) | | | | | | | |
| Notched Izod Impact Strength | | 1.0 | ft-lb/in | 0.3 | ft-lb/in | 0.6 | ft-lb/in |
| (73° F., Method A) | | | | | | | |
| Tensile at Yield | | 6100 | psi | 5400 | psi | 4100 | psi |

The choice of each virgin resin A-D in the blend was determined by factors such as properties of virgin resins A-D, ease of blending, properties required in the final blend, etc. For example, ultra-high melt flow rate (VRA) allowed reduced processing temperatures, thus saving energy cost. Resin with ultra-high melt flow rate were also added to target compositions with a MFR of about 20. Resin with very low MFR (VRC) was added to target final composition with MFR of about 4 to about 12. Resin with medium MFR (example nucleated polypropylene homopolymer VRB) were used as a building block for applications that require high flow and high stiffness.

### Post-Consumer Recyclate Resin

The PCR resin used in the examples described herein was a high density polyethylene (HDPE) obtained from recycled milk jugs and prepared according to US2013015604. However, any PCR resin obtained from blow molded containers could have been used.

In particular, the HDPE milk jugs in the presently described examples were washed and ground, and sorted into flakes, which were cleaned in a wash line. The plastic flakes were melted and formed into pellets, and then put through a proprietary process using heat and air to purify the plastic without the use of chemicals. As a result, even though recycled, the FDA allows its use at levels up to 100% in HDPE packaging for fatty foods and spirits.

Certain properties of the recycled PCR used in the present examples are shown in

TABLE 2
Table 2: Properties of Recycled PCR

| | ASTM |
|---|---|
| Physical Properties | |
| Density 0.958-0.965 g/cm³ | D792 |
| MFR 0.5-0.85 g/10 min at 2.16 kg, 190° C. | D1238 |
| Moisture <0.050% | D6980 |
| Mechanical Properties | |
| Flex Modulus 111,500 psi | D790 |
| Elongation at Break 197% | D638 |
| Impact resistance 4.5 ft-lb/in | D256 |
| Mold shrinkage Length 2.98% | |
| Mold shrinkage Width 2.6% | |

### Compatibilizers

Eight compatibilizers were used in the examples presented herein. These were all obtained from LyondellBasell. The compatibilizers were reactor made HECOs or thermoplastic olefins (TPO) containing polymer chains composed of sections of PP, PE, and butene. These compatibilizers were labeled compatibilizer CA-CH. Each of the compatibilizers CA-CH contained two components A and B. Component A was a propylene homopolymer with a MFR of between 10 g/10 min to about 200 g/10 min. Component B was copolymer of ethylene with propylene with varying ethylene content from about 10% to about 60% ethylene content or partially amorphous copolymer of ethylene and propylene containing about 25-60% ethylene. The composition of the compatibilizers is shown in Table 3.

TABLE 3
COMPOSITION AND PROPERTIES OF COMPATIBILIZERS

| | | | | | | | Intrinsic |
|---|---|---|---|---|---|---|---|
| | | | | | | | Viscosity |
| | | | | | | | of xylene |
| | | | MFR of A | | % B | Ethylene | soluble |
| | | % A (by | (g/10 | | (by | Content | fraction |
| Compatibilizer | Component A | weight) | min) | Component B | weight) | (%) | at RT |
| CA | Crystalline | 77% | 12 | Partially | 23% | 44% | 4 dl/g (in |
| | propylene | | | amorphous | | | decalin) |
| | homopolymer | | | copolymer of | | | |
| | | | | ethylene and | | | |
| | | | | propylene | | | |
| CB | Crystalline | 79% | 150 | Partially | 21% | 44% | 4 dl/g (in |
| | propylene | | | amorphous | | | decalin) |
| | homopolymer | | | copolymer of | | | |
| | | | | ethylene and | | | |
| | | | | propylene | | | |
| CC | 50% Al + 50% | 70% | Al = 5 | copolymer of | 30% | 36% | 8.2 dl/g |
| | All (Al and All | | All = 50 | ethylene and | | | (in |
| | = | | | propylene | | | tetrahydr |
| | polypropylene | | | | | | onaphthal |
| | homopolymer) | | | | | | ene) |
| CD | 54% Al | 65% | 90 | Partially | 35% | 48% | 3.2 dl/g |
| | (crystalline | | | amorphous | | | (in |
| | propylene | | | copolymer of | | | decalin) |
| | homopolymer)+ | | | ethylene and | | | |
| | 11% All | | | propylene | | | |
| | (high density | | | | | | |
| | PE) | | | | | | |
| CE | 32.5% Al + | 63.5% | 85 | Partially | 36.5% | 52% | 2.8 dl/g |
| | 31% All | | | amorphous | | | (in |
| | (Al and All = | | | copolymer of | | | decalin) |
| | crystalline | | | ethylene and | | | |
| | propylene | | | propylene | | | |
| | homopolymer) | | | | | | |
| CF | Crystalline | 30% | | Partially | 70% | 16% | 20% |
| | propylene | | | amorphous | | | soluble in |
| | homopolymer | | | copolymer of | | | xylene |
| | | | | ethylene and | | | |
| | | | | butene | | | |
| CG | Semi- | 50% | | Bipolymer of | 50% | 25- | |
| | crystalline | | | propylene and | | 50% | |
| | propylene | | | ethylene | | | |
| | homopolymer | | | | | | |
| CH | Crystalline | 74% | 56 | Partially | 26% | 51% | 3.0 dl/g |
| | propylene | | | amorphous | | | (in |
| | homopolymer | | | copolymer of | | | decalin) |
| | | | | ethylene and | | | |
| | | | | propylene | | | |

### Impact Modifier

The impact modifier used in the examples below was INFUSE™ (IM1) from DOW® Inc. (Houston, TX). Physical properties for the impact modifiers and test methods are shown in Table 4.

TABLE 4
POLYETHYLENE IMPACT MODIFIER IM1- (INFUSE ™)

Physical Properties
Density 0.877 g/cm³ (ASTM D792)
MFR 15 g/10 min @Load 2.16 kg, Temperature 190° C. (ASTM D1238)
Mechanical Properties
Hardness, Shore A 71 (ASTM D2240)
Tensile Strength at Break 1020 psi (7.0 MPa) (ASTM D412)
Tensile Modulus - 100% Secant
(Compression Molded) 335 psi (2.31 MPa) (ASTM D638)
Tensile Elongation Break,
Compression Model 1500% (ASTM D638)
Elastomers
Tensile Strength at Break 1020 psi (7.0 MPa) (ASTM D412)
Tensile Elongation at Break 1700% (ASTM D412)
Tear Strength 177 lbf/in (31.0 kN/m) (ASTM D624)
Compression Set
70° F. (21° C.). 15% (ASTM D395)
158° F. (70° C.) 58%
Thermal Properties
Melting Point (DSC) 248° F. (120° C.) Dow Method
TMA (39.4 mil (1.00 mm)) 203° F. (95° C.) Dow Method

### Blending

Comparative resins were formed by mixing virgin resin (VRA-C) and PCR resin with no added compatibilizer. These were labeled as comparative examples 1 through 4 (C1-4). The composition of the comparative examples C1-C4 are shown in Table 5.

TABLE 5
COMPARATIVE EXAMPLES - VIRGIN
RESIN & PCR RESIN ONLY

| Resin | VRA (wt. %) | VRB (wt. %) | VRC (wt. %) | PCR (wt. %) |
|---|---|---|---|---|
| C1 | 0 | 75 | 0 | 25 |
| C2 | 0 | 65 | 30 | 5 |
| C3 | 4.7 | 59.6 | 20.7 | 15 |
| C4 | 16.3 | 43.7 | 0 | 40 |

Resin blends were obtained by mixing one or more of the virgin resins (VRA-D), post-consumer recyclate HDPE resin, and the HECO or TPO compatibilizers CA-CH. Twenty-three such mixed resin blends were prepared. The mixed blends containing virgin resin, PCR and compatibilizers were labeled B1-B23. The compositions of the mixed blends are presented in Table 6.

TABLE 6
COMPOSITION OF BLENDS B 1-23

| | VRA | VRB | | VRD | | | Compati- |
|---|---|---|---|---|---|---|---|
| | (wt. | (wt. | VRC | (wt. | PCR | Compati- | bilizer |
| Blend | %) | %) | (wt. %) | %) | (wt. %) | bilizer | (wt. %) |
| B1 | 17.7 | 31.1 | 0 | 0 | 25 | CA | 26.1 |
| B2 | 20 | 20.9 | 27.9 | 0 | 5 | CA | 26.1 |
| B3 | 0 | 58.9 | 20.70 | 0 | 15 | CA | 26.1 |
| B4 | 33.8 | 43.70 | 00 | 0 | 40 | CA | 26.1 |
| B5 | 0 | 45.8 | 3 | 0 | 25 | CA | 26.1 |
| B6 | 7.4 | 54.5 | 0 | 0 | 25 | CA | 13 |
| B7 | 31.4 | 0 | 0 | 0 | 25 | CA | 43.5 |
| B8 | 14.8 | 10 | 0 | 0 | 25 | CA | 50 |
| B9 | 0 | 34.9 | 8.9 | 0 | 30 | CA | 26.1 |
| B10 | 0 | 23.8 | 0 | 0 | 50 | CA | 26.1 |
| B11 | 0 | 46.3 | 0 | 0 | 25 | CB | 28.6 |
| B12 | 0 | 26.1 | 20.1 | 0 | 25 | CB | 28.7 |
| B13 | 0 | 21.4 | 0 | 0 | 50 | CB | 28.5 |
| B14 | 22.7 | 32.3 | 0 | 0 | 25 | CC | 20 |
| B15 | 2.0 | 73 | 0 | 0 | 5 | CC | 20 |
| B16 | 10 | 55 | 0 | 0 | 15 | CC | 20 |
| B17 | 3.4 | 54.5 | 0 | 0 | 25 | CD | 17.1 |
| B18 | 3.1 | 55.5 | 0 | 0 | 25 | CE | 16.4 |
| B19 | 2.4 | 64 | 0 | 0 | 25 | CF | 8.6 |
| B20 | 0 | 58 | 0 | 0 | 25 | CF | 17 |
| B21 | 13.1 | 49.7 | 0 | 0 | 25 | CG | 12.2 |
| B22 | 0 | 0 | 0 | 30 | 30 | CH | 40 |
| B23 | 10 | 0 | 0 | 20 | 30 | CH | 40 |

### Comparison of Physical Properties

Physical properties of the comparative blends C1-C4 (no compatibilizer or impact modifier added) and of all the mixed blends B1-B23 (just compatibilizer added) were measured. These physical properties included MFR, Flexural Modulus, Notched Izod, Elongation at Break and at yield, tensile at break and at yield. The physical properties are shown in Table 7.

TABLE 7
PHYSICAL PROPERTIES OF EXEMPLARY RESINS

| | | | | Elon- | Elon- | Tensile | |
|---|---|---|---|---|---|---|---|
| | MFR | Flex. | Notched | gation | gation | at | Tensile |
| | (g/10 | Mod. | Izod (ft- | at Break | on Yield | Break | at Yield |
| Blend | min) | (kpsi) | lb/in) | (%) | (%) | (psi) | (psi) |
| C1 | 36 | 256 | 0.36 | 4.7 | 4.7 | 5110 | 5120 |
| C2 | 20 | 306 | 0.42 | 16 | 6.0 | 4430 | 5700 |
| C3 | 22 | 285 | 0.38 | 12 | 6.4 | 5090 | 5640 |
| C4 | 31 | 234 | 0.35 | 4.4 | N/A | 4810 | |
| B1 | 23 | 207 | 1.06 | 11 | 6.0 | 3920 | 4310 |
| B2 | 13 | 252 | 0.96 | 76 | 5.8 | 1980 | 4810 |
| B3 | 24 | 242 | 0.87 | 25 | 5.3 | 3760 | 4720 |
| B4 | 29 | 187 | 0.86 | 6.1 | 5.7 | 4050 | 4090 |
| B5 | 12 | 217 | 1.09 | 21 | 6.7 | 3430 | 4520 |
| B6 | 27 | 236 | 0.67 | 7.6 | 5.9 | 4710 | 4840 |
| B7 | 24 | 180 | 1.47 | 12 | 5.7 | 3260 | 3780 |
| B8 | 9.0 | 171 | 2.42 | 37 | 7.4 | 2430 | 3750 |
| B9 | 7.7 | 214 | 1.25 | 120 | 8.0 | 190 | 4540 |
| B10 | 3.9 | 179 | 11.85 | 200 | 9.3 | 192 | 4190 |
| B11 | 29 | 213 | 0.88 | 7 | 5.2 | 3980 | 4250 |
| B12 | 9.2 | 226 | 1.12 | 20 | 7.4 | 3080 | 4560 |
| B13 | 9.5 | 177 | 3.41 | 18 | 8.7 | 3580 | 4140 |
| B14 | 18 | 213 | 1.09 | 36 | 7.3 | 2300 | 4560 |
| B15 | 24 | 250 | 0.89 | 57 | 5.8 | 3160 | 4890 |
| B16 | 19 | 228 | 1.07 | 44 | 6.4 | 2340 | 4680 |
| B17 | 27 | 220 | 0.79 | 6.1 | 5.2 | 4150 | 4310 |
| B18 | 30 | 227 | 0.69 | 5 | 4.8 | 4300 | 4350 |
| B19 | 31 | 237 | 0.38 | 6.1 | 6.1 | 4850 | 4860 |
| B20 | 22 | 217 | 0.44 | 9.9 | 7.4 | 4400 | 4510 |
| B21 | 26 | 204 | 0.96 | 14 | 6.3 | 3890 | 4360 |
| B22 | 17 | 164 | | 8.7 | 6.4 | 3140 | 3470 |
| B23 | 27 | 168 | 3.00 | 5.7 | 5.2 | 3370 | 3480 |

It can be seen from Table 7 that the addition of the compatibilizer changed the physical properties as compared to the comparative compositions C1-C₄. As a general trend, the blends B1-23 (containing compatibilizer), showed a lower Flexural Modulus values compared with the comparative examples C1-C4. This indicates that C1-C4 were more flexible than blends with added compatibilizer. A decrease in Flexural Modulus of about 20% was observed on the addition of compatibilizer and a ˜100% increase in the Notched Izod value was seen, while keeping the MFR more-or-less same. An increase in the % of Elongation at Break was also observed in blends containing the compatibilizers.

Typically, materials with a higher Notched Izod value are tougher and those with lower Notched Izod value tend to be brittle. The blends containing compatibilizer were tougher than those blended without a compatibilizer. For example, in comparing physical properties of blends C3 and B3, both of which contain about 59.5 wt % VRB and about 20 wt % VRC, and about 15 wt. % PCR, it was found that although both C3 and B3 have similar MFR values, their Flexural Modulus vary significantly. B3-which also contains 26 wt. % of HECO containing compatibilizer CA, has higher Notched Izod value (0.87 lb/in) compared to that of C3 (0.38 1b/in). This increase indicated that plastic B3 has higher impact strength and is therefore tougher compared to plastic C3.

Elongation at Break is a measure of ductility of a material indicating how much a material can be stretched before it breaks. Materials with higher Elongation at Break show higher ductility. Nearly 100% increase in the value Elongation at Break was seen for C3 (12%) compared to B3 (25%), implying that on adding the compatibilizer, the plastic blend is more ductile, that is, it is more likely to deform without breaking.

Thus, by blending appropriately, highly variable resins may be obtained with different mechanical properties. The increased values of Notched Izod and only slightly reduced values of Flexural Modulus in the blended resins compared with C1-C4 indicate that these blends have increased impact strength while maintaining or slightly increasing their flexibility.

### PCR Blends with Impact Modifier

In this proof of concept work, we tested an impact modifier from DOW® known as INFUSE™ 9817. The available properties of this material are given in Table 8.

TABLE 8
INFUSE 9817
Fabrication Method (Injection Molding)

Physical Properties
Density 0.877 g/cm³ (ASTM D792)
MFR 15 g/10 min @Load 2.16 kg, Temperature 190° C. (ASTM D1238)
Mechanical Properties
Hardness, Shore A 71 (ASTM D2240)
Tensile Strength at Break 1020 psi (7.0 MPa) (ASTM D412)
Tensile Modulus - 100% Secant
(Compression Molded) 335 psi (2.31 MPa) (ASTM D638)
Tensile Elongation Break,
Compression Model 1500% (ASTM D638)
Elastomers
Tensile Strength at Break 1020 psi (7.0 MPa) (ASTM D412)
Tensile Elongation at Break 1700% (ASTM D412)
Tear Strength 177 lbf/in (31.0 kN/m) (ASTM D624)
Compression Set
70° F. (21° C.). 15% (ASTM D395)
158° F. (70° C.) 58%
Thermal Properties
Melting Point (DSC) 248° F. (120° C.) Dow Method
TMA (39.4 mil (1.00 mm)) 203° F. (95° C.) Dow Method

In further examples, the amount of impact modifier (IM1=INFUSE™ 9817) was sequentially increased in the blends. Table 9 below shows the composition of the blends along with their properties. Addition of impact modifier improved impact of the compounded plastic and maintained MFR. In the blends 16-9 in the Table, the PCR content was maintained at 20 wt. % while the wt. % of the impact modifier was increased from 0-20 wt. %.

TABLE 9
PROPERTIES OF POLYMER WITH IMPACT MODIFIER

| | | | | % | | | | Tensile | |
|---|---|---|---|---|---|---|---|---|---|
| | | HECO | | Impact | MFR | Flex | N | at | Elongation |
| | VRA | compatibilizer | | Modifier | (g/10 | Mod | Izod | Yield | at Yield |
| Blend | (wt. %) | (wt. %) () | % PCR | IM1 | min) | (kpsi) | (ft-lbs/in) | (%) | (%) |
| 11 | 55 | 45 | 0 | 0 | 50 | 160 | 2.3 | 3100 | 5 |
| 12 | 25 | 45 | 30 | 0 | 51 | 162 | 0.5 | 2470 | 2.4 |
| 13 | 23 | 43 | 28 | 5 | 55 | 132 | 1.27 | 2340 | 3.3 |
| 14 | 21 | 41 | 26 | 10 | 50 | 119 | NB | 2230 | 4 |
| 15 | 18 | 38 | 23 | 20 | 48 | 102 | NB | 2050 | 10 |
| 16 | 15 | 65 | 20 | 0 | 48 | 153 | 1 | 2480 | 3.1 |
| 17 | 15 | 60 | 20 | 5 | 45 | 133 | 2.14 | 2470 | 4.2 |
| 18 | 15 | 55 | 20 | 10 | 41 | 118 | NB | 2300 | 5.9 |
| 19 | 15 | 45 | 20 | 20 | 42 | 101 | NB | 1980 | 10 |

The MFR value upon increasing the impact modifier content did not change much, from 48 g/10 min with no added impact modifier (16) to 42 g/10 min upon addition of 20 wt. % impact modifier (19). By adjusting the ratio of PCR content and the impact modifier, the MFR of the resulting blend can be maintained to any desired value for the application.

As discussed earlier in the disclosure, Notched Izod test is a measure of the material's resistance to impact from a swinging pendulum. Larger values of Notched Izod signify compositions that are more impact resistant. Notched Izod values of blends containing impact modifier showed a general increase. Thus, the plastics blended with the addition of the impact modifier were tougher than plastics without impact modifier. Also, on increasing the amounts of impact modifier added to the blend, the impact strength, and thus toughness increased, as shown by increase in the Notched Izod of the blends. For example, the Notched Izod of 16 (containing no IM1) was 1 and that of 17 (containing 5 wt. % IM1) was 2.14, indicating that I7 is a tougher material than I6.

Some proposed blends of virgin resins, HECO compatibilizers, PCR and varying amounts of different impact modifiers may be made with ratios shown in Table 10. We believe that these proposed blends would show similar trends of retaining MFR values and increased toughness of the polymer upon increasing impact modifier wt. %. Varying desired property blends could be similarly made.

TABLE 10
PROPOSED BLENDS

| | | HECO | | |
|---|---|---|---|---|
| | Virgin Resin | compatibilizer | | % Impact |
| Blend | (wt. %) | (wt. %) | % PCR | Modifier |
| E1 | 55 | 45 | 0 | 0 |
| E2 | 55 | 25 | 15 | 5 |
| E3 | 55 | 10 | 25 | 10 |
| E4 | 35 | 60 | 5 | 0 |
| E5 | 35 | 55 | 15 | 5 |
| E6 | 35 | 10 | 35 | 20 |
| E7 | 15 | 60 | 25 | 0 |
| E8 | 15 | 60 | 20 | 5 |
| E9 | 15 | 60 | 15 | 20 |

We expect that we will test other impact modifiers as the work continues, and we predict that similar trends will be observed.

The ranges of physical properties displayed by resins containing compatibilizers and impact modifiers allow for selection of the resins for a broad number of applications. For example, resins with Notched Izod value of about 0.50 to no break (NB), and Elongation at Yield value of about 2 to about 10, Tensile at Yield between 1500 to 4000 psi (example B1, B2, B5, B9, B12, 17 and 18, etc.) may be appropriate for cap and closure applications. These include applications in beverage packaging, non-food packaging and cosmetic packaging. Properties like enhanced tamper-resistance, stress-crack resistance, high temperature resistance and processability are required for such applications. The resins for such can be chosen by addition of appropriate compatibilizers and impact modifier in the blend of virgin PP and PCR PE resins to obtain desired physical properties for the specified applications.

Material for other consumer products including low-pressure pipe, plastic bags, sheets, crates, containers, packaging material or a film, and the like, can also be chosen from the appropriate blending of virgin plastics and PCR, with compatibilizers and varying amounts of impact modifiers.

Additional experiments with polymers containing varying amounts of compatibilizers and impact modifiers are ongoing, and the trends demonstrated herein are expected to generally hold true.

The following references are each incorporated by reference in their entireties for all purposes. The ASTM standards cited herein are used to measure the characteristics of the claimed polymers.

ASTM D1238, Standard Test Method for Melt Flow Rates of Thermoplastics by Extrusion Plastometer (2020).

ASTM D1505-18, Standard Test Method for Density of Plastics by the Density-Gradient Technique, ASTM International, West Conshohocken, P A, 2018.

ASTM D2240 Standard Test Method for Rubber Property-Durometer Hardness (2015)

ASTM D256-06, Standard Test Methods for Determining the Izod Pendulum Impact Resistance of Plastics.

ASTM D395 Standard Test Methods for Rubber Property-Compression Set (2018)

ASTM D412 Standard Test Methods for Vulcanized Rubber and Thermoplastic Elastomers-Tension (2016).

ASTM D5492-17, Standard Test Method for Determination of Xylene Solubles in Propylene Plastics, ASTM International, West Conshohocken, P A, 2017.

ASTM D638 Standard Test Method for Tensile Properties of Plastics (2022)

ASTM D790-03, Standard Test Methods for Flexural Properties of Unreinforced and Reinforced Plastics and Electrical Insulating Materials.

ASTM D792 Standard Test Methods for Density and Specific Gravity (Relative Density) of Plastics by Displacement (2020)

ITM 20061, Infrared Spectrophotometric Determination of Ethylene Content in Propylene-Ethylene Semi crystalline Copolymers.

ISO 1628-1, Plastics-Determination of the viscosity of polymers in dilute solution using capillary viscometers.

U.S. Pat. No. 7,592,393 Soft polyolefin compositions

U.S. Pat. No. 8,008,400 Polyolefin masterbatch and composition suitable for injection molding

EP0640648 Polyolefin compositions having a high balance of stiffness and impact strength.

EP0472946 Elastoplastic polyolefin compositions.

WO2016207235 HDPE-containing impact modifier polyolefin composition.

U.S. Pat. No. 10,124,527 Extrusion process for polyethylene polymers.

WO2016207236 LLDPE-containing impact modifier polyolefin composition

US2012184675 Elastoplastic polyolefin compositions having low gloss

US2013015604 Process of Producing PCR Pellets.

1. A composition comprising:
a) a virgin resin having a first polyolefin;
b) a post-consumer recyclate (PCR) resin having a second polyolefin;
c) a compatibilizer, wherein the compatibilizer has a semi-crystalline homopolymer matrix and a rubber component; and
d) an impact modifier.

2. The composition of claim 1, wherein the first polyolefin is selected from a group consisting of polyethylene, polypropylene, and C₄-C₁₀ alpha olefins.

3. The composition of claim 1, wherein said PCR is a high density polyethylene (HDPE).

4. The composition of claim 1, wherein the impact modifier is a copolymer of ethylene and an olefin selected from the group consisting of butene, hexene and 1-octene.

5. The composition of claim 4, wherein the impact modifier is a copolymer of ethylene and butene, a copolymer of ethylene and octene, or copolymer of ethylene and hexene.

6. The composition of claim 4, wherein the impact modifier is styrene-containing block copolymer.

7. The composition of claim 1, wherein the virgin resin is present in an amount of about 15 to about 55 wt. %.

8. The composition of claim 1, wherein the post-consumer recyclate is present in an amount of about 5 to about 50 wt. %, or an amount of about 5 to about 35 wt. %, or an amount of about 15 to about 35 wt. %.

9. The composition of claim 1, wherein the compatibilizer is present in an amount of about 5 to about 65 wt. %, or an amount of about 30 to about 60 wt. %.

10. The composition of claim 1, wherein the impact modifier is in an amount of 5 to about 20 wt. % or alternatively, about 10 to about 20 wt. %.

11. The composition of claim 1, wherein the MFR of said composition is about 40 to 60 g/10 min; alternatively, from 15 to about 30 g/10 min; alternatively, from 20 to 40 g/10 min.

12. The composition of claim 1, wherein the virgin resin is an amount of 15 wt. %, PCR resin is in an amount of 20 wt. %, polypropylene-based compatibilizer is in an amount of 55% and impact modifier is in an amount of 10 wt. %, with the composition MFR of about 30-50 or about 41 g/10 min.

13. The composition of claim 1, wherein the compatibilizer comprises:
a. 20% to about 80% by weight a semi-crystalline propylene homopolymer with a melt flow index of about 20 to about 60 g/10 min; and
b. 20% to 80% by weight partially amorphous copolymer is ethylene and propylene with an ethylene content of about 15 to about 52% and the intrinsic viscosity of the xylene soluble fraction at room temperature of about 3.0 to 5.0 dl/g (in decalin).

14. The composition of claim 13, wherein semi-crystalline propylene homopolymer (a) further comprises:
i. 25% to 75% of a propylene polymer by weight of semi-crystalline propylene homopolymer (a), having a melt flow rate of about 1.2 g/10 min,
ii. 25% to 75% of a propylene polymer by weight of semi-crystalline propylene homopolymer (a), having a melt flow rate of about 73 g/10 min,
wherein the ratio of melt flow rate of component ii and i is 60 and the propylene polymers i and ii are selected from a group consisting of a propylene homopolymer, a random copolymer of propylene containing up to 5% of ethylene, and a random copolymer of propylene containing up to 6% of at least one C4-C10 alpha-olefin and optionally up to 5 of ethylene; wherein a has a polydispersity index from 4 to 7.

15. A composition comprising:
a) 15 to about 55 wt. % of a virgin resin having a polypropylene homopolymer;
b) 5 to about 50 wt. % of a high density polyethylene (HDPE) post-consumer recyclate (PCR);
c) 5 to about 65 wt. % of a compatibilizer, wherein the compatibilizer has a semi-crystalline propylene homopolymer and a partially amorphous copolymer of ethylene and propylene; and
d) 5 to about 20 wt. % of an impact modifier containing copolymer of ethylene and octene.

16. The composition of claim 15, wherein said composition has any combination of the following properties:
a) a flexural modulus between about 100-200 kpsi;
b) a Notched Izod between about 0.5 and 2.5 ft-lbs/in;
c) a Tensile at Yield between about 1000-4000%; and,
d) an elongation at yield of about 1-10%.

17. An article formed from the composition of claim 1.

18. An article formed from the composition of claim 14.

19. A method of making a blended resin, comprising adding ingredients i) through v) to a twin screw extruder and blending them to form a blended resin, wherein ingredients i) through v) are i) a virgin resin with a first polyolefin; ii) a post-consumer recyclate or PCR resin having a second polyolefin; iii) a compatibilizer having a semi-crystalline matrix and a rubber component, and iv) an impact modifier.

20. The method of claim 19, wherein said twin screw extruder temperature is at a range of 125-299° C. or is about 150° C. at a feed throat and 220° C. at a die; wherein said twin screw extruder output is 50-150 lbs/hr or is about 100 lbs/hr; wherein said twin screw extruder mechanical energy is 0.15-0.5 kW/Kg/hr or is about 0.25 kW/Kg/hr; and wherein said twin screw extruder speed is 200-400 rpm or about 300 rpm.
